(19) United States
(12) Patent Application Publication
(10) Pub. No.: US 2026/0278335 A1
(43) Pub. Date: Sep. 17, 2026

(54) ENSEMBLING EMBEDDING MODELS

(71) Applicant: GDM Holding LLC, Mountain View, CA (US)

(72) Inventors: Alan Patrick Mackey, Mountain View, CA (US); Elad Eban, Sunnyvale, CA (US); Piotr Zielinski, New Providence, NJ (US); Ekaterina Datsenko, Mountain View, CA (US)

(21) Appl. No.: 19/568,460

(22) Filed: Mar. 16, 2026

Related U.S. Application Data
(60) Provisional application No. 63/772,349, filed on Mar. 14, 2025.

(51) Int. Cl. G06N 3/045

(52) U.S. Cl. CPC G06N 3/045

(57) ABSTRACT

Systems and methods for ensembling embeddings generated by multiple neural networks. In particular, the embeddings generated by the neural networks for a given data item are first aligned and then combined to generate a combined embedding of the given data item.

### CROSS-REFERENCE TO RELATED APPLICATIONS

This application claims the benefit under 35 U.S.C. § 119(e) of U.S. Patent Application No. 63/772,349, filed on Mar. 14, 2025. The disclosure of the foregoing application is incorporated herein by reference in its entirety for all purposes.

### BACKGROUND

This specification relates to processing data using machine learning models.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that ensembles the outputs of multiple different embedding neural networks when processing a given data item.

The subject matter described in this specification can be implemented in particular embodiments so as to realize one or more of the following advantages.

Representation, embedding, or feature models which map data into an embedding space rather than to a label space are behind many major recent advances in machine learning. They enable multimodality, zero-shot classification, and search and retrieval, among other applications.

However, basic techniques such as ensembling which are well known to improve performance in the context of traditional predictive models cannot be naively applied to embedding models.

For example, rather than being trained to predict a label (either discrete or continuous) per example, embedding models are generally trained according to an objective concerned with the similarity between examples (e.g., contrastive or triplet loss) or between examples and learned proxies (e.g., classification losses). Because of this, the learned embeddings become invariant at least to an orthogonal transformation and possibly to any linear transformation. As a result, standard techniques for combining or improving predictive models such as ensembles and cascades cannot be directly applied to embedding models.

While it is possible to simply concatenate embeddings, doing so increases dimensionality which can be costly in terms of memory consumption and processor cycles, especially for models that generate embeddings having large embedding sizes. Additionally, while concatenation preserves all information available in each constituent embedding, it loses the variance-reduction benefit of ensembling. As an example, consider the outcome of training a linear classifier on the concatenation of many embeddings which are noisy copies of each other. Such a classifier will eventually begin to overfit as the number of redundant, noisy features increases. In other words, existing techniques for ensembling embeddings, e.g., concatenation, are (i) ineffective and (ii) greatly increase the computational requirements required for the downstream task that operates on the ensembled embeddings.

This specification addresses these issues by ensembling embeddings from multiple different embedding models by first aligning the embeddings before combining them. This results in ensembled embeddings that outperform both baseline ensembling techniques, e.g., concatenating embeddings or principal component analysis (PCA), and the individual embeddings that make up the ensemble on a variety of downstream tasks, e.g., retrieval or k nearest neighbors (KNN) classification settings as well as when training classifiers on top of the embeddings, with these results holding across multiple domains and for unseen classes.

In other words, the described techniques more effectively compress the input data item than existing embedding ensembling approaches, i.e., achieve a greater compression rate because the combined embedding matches the dimensionality of the initial embedding generated as output by one or more of the embedding networks, while performing better when used for downstream tasks.

Advantageously, the respective learned transformation(s) used to align the embeddings can be learned without requiring access to the trained parameters of the embedding neural networks and without needing to retrain any of the embedding neural networks. Thus, the system can effectively ensemble any appropriate available embedding neural networks to enrich the representations generated by the system.

Moreover, because the respective learned transformation is relatively computationally efficient, e.g., a linear transformation or a computationally efficient non-linear transformation, e.g., an MLP or other relatively small neural network, the learning can be performed in a computationally efficient manner.

Additionally, generating the ensembled embedding can be done at inference time with relatively little computational overhead relative to only performing the processing required to generate the multiple different embeddings for the multiple different embedding neural networks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network system.

FIG. 2 is a flow diagram of an example process for processing a data item using a plurality of embedding neural networks.

FIG. 3 is a flow diagram of an example process for learning the learned transformation.

FIG. 4 shows an example of the performance of the described techniques.

Like reference numbers and designations in the various drawings indicate like elements.

### DETAILED DESCRIPTION

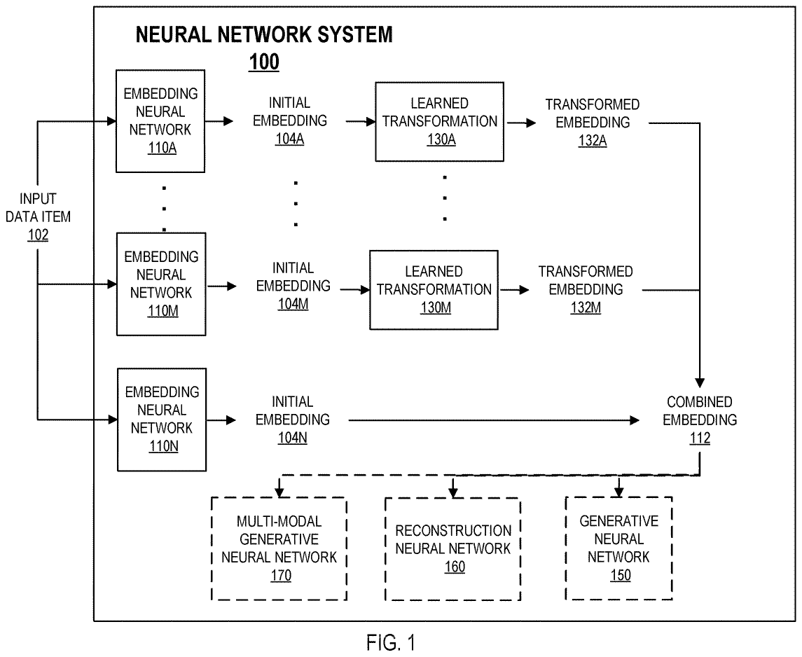

FIG. 1 shows an example neural network system 100. The neural network system 100 is an example of a system implemented as computer programs on one or more computers in one or more locations in which the systems, components, and techniques described below are implemented.

The system 100 ensembles the outputs of multiple different embedding neural networks 110A-N when processing a given data item 102.

More specifically, the system 100 generates a “combined” embedding 112 of any given data item 102 by ensembling respective initial embeddings 104A-N generated by multiple different embedding neural networks 110A-N.

“Ensembling” embeddings refers to generating a single “combined” embedding 112 of a given data item 102 from multiple different initial embeddings 104A-N generated by multiple different embedding neural networks 110A-N.

For example, each data item 102 can be e.g., an image (that is, one or more intensity values associated with each of an array of pixels, e.g., a 2-dimensional array), an audio signal, or a video (that is, an ordered sequence of video frames which are images). An audiovisual item with an audio track and a video is here considered a type of video. In the case of an image or video, the system forms the combined embedding based on pixel-level data in the image or video. The image or video may be one captured from the real-world (by a camera device), and the audio signal may be one captured from the real-world (e.g., by a microphone).

An “embedding” as used in this specification can refer to a single embedding vector or a collection of multiple embedding vectors. An embedding vector is a vector of numerical values, e.g., floating point or other numerical values, having a specified dimensionality.

For example, the embedding of an image can be a single embedding vector or a collection of multiple embedding vectors that includes a respective embedding vector for each of multiple regions (“patches”) of the image.

As another example, the embedding of a video can be a single embedding vector or a collection of multiple embedding vectors that includes a respective embedding vector for each of multiple regions of the video. The regions can be respective patches of different video frames in the video or can be spatio-temporal regions that each include co-located patches from multiple different video frames.

As another example, the embedding of an audio signal can be a single embedding vector or a collection of multiple embedding vectors, e.g., that includes a respective embedding vector for each of multiple time windows during the audio signal or each of multiple regions within a spectrogram representing the audio signal.

In particular, each embedding neural network 110A-N is configured to process an input data item 102 to generate an initial embedding 104A-N of the input data item 102.

Each embedding neural network 110A-N can have a different architecture, can have been trained on different training data, can have been trained on a different training loss, can have been trained with a different set of hyperparameters, or some combination of the above. As a result, initial embeddings of the same input data item generated by different ones of the embedding neural networks can be different from one another, e.g., can represent different properties of the data item or otherwise capture different aspects of the data item.

Generally, each embedding neural network 110A-N can have any appropriate architecture, e.g., can be a Transformer neural network, a vision Transformer (ViT) neural network, convolutional neural network, e.g., a ResNet, a recurrent neural network, a state space model (SSM), and so on.

That is, any given embedding neural network 110A-N can have any architecture that is appropriate for mapping a data item of a corresponding type to an output that includes an embedding. As specific examples, when the data item 102 is an image or a video, the embedding neural network can be a ViT, a convolutional neural network, or a neural network that includes both attention layers and convolutional layers. As another specific example, when the data item 102 is an audio signal, the embedding neural network can be a recurrent neural network or a convolutional neural network. Other types of neural network architectures can also be used.

More specifically, the system 100 receives a data item 102.

The system 100 then generates a respective embedding of the data item 102 for each of the plurality of embedding neural networks 110A-N.

As part of generating the embeddings, the system 100 processes the data item 102 using each of the plurality of embedding neural networks 110A-N to generate a respective initial embedding 104A-N of the data item for each embedding neural network 110A-N.

For each of one or more of the embedding neural networks 110A-N, the system 100 then applies a respective learned transformation 130A-M for the embedding neural network 110A-M to the respective initial embedding 104A-M of the data item for the embedding neural network 110A-M to generate a respective transformed embedding 132A-M. The system 100 then uses the respective transformed embedding 132A-M as the embedding of the data item for the embedding neural network 110A-M.

When the initial embedding includes multiple different embedding vectors, the respective learned transformation 130A-M can be applied to each one of the embedding vectors to generate the transformed embedding 132A-M.

In some cases, the system 100 generates a respective transformed embedding 132A-M for each of the embedding neural networks 110A-N.

In some other cases, the system 100 generates a respective transformed embedding 132A-M for less than all of the embedding neural networks 110A-N, i.e., for only a proper subset of the embedding neural networks 110A-N.

In this example, for any embedding neural network 110A-N that is not in the proper subset, the system 100 can use the initial embedding 104A-N of the data item 102 generated by the embedding neural network 110A-N as the embedding of the data item 102 for the embedding neural network 110A-N.

By generating the transformed embeddings 132A-M, the system 100 “aligns” the embeddings so that the final embedding generated for the multiple different embedding neural networks are each in a shared space, allowing them to be effectively combined.

The system 100 then combines the respective embeddings for the plurality of embedding neural networks to generate a combined embedding 112 of the data item. For example, the system 100 can average the embeddings or can determine a weighted sum of the embeddings.

The system 100 then performs a downstream task on a task input that includes the combined embedding of the data item.

By performing the downstream task using a combined embedding that has been generated as described in this specification, the system 100 is able to generate higher quality outputs for the downstream task because the combined embedding provides a richer representation of the underlying data item than the initial embedding generated by any one of the embedding neural networks 110A-N (or an embedding generated by conventional ensembling techniques).

For example, the combined embedding can be used to train a generative neural network 150 that generates data items conditioned on combined embeddings. One example of such a neural network is an image generation neural network that generates images conditioned on combined embeddings. That is, the image generation neural network can receive an input that includes a combined embedding and generate an output image conditioned on the discrete representation. For example, the generated image can be a reconstruction of an image that would be represented by the combined embedding. As another example, the input to the image generation neural network can include another conditioning input, and the generated image can be a reconstruction of an image that would be represented by the combined embedding but modified as indicated by the other conditioning input. Alternatively, the input to the image generation neural network can include only another type of conditioning input, and the image generation neural network can generate a discrete representation of the output image.

As another example, the combined embedding can be used for data item compression, e.g., so that the combined embedding is used to later reconstruct an input data item by a reconstruction neural network 160. That is, the system 100 can generate a compressed representation of the combined embedding, e.g., by using the combined embedding as the compressed representation or by further compressing the compressed representation. The system 100 can then later generate an input to the reconstruction neural network 160 from the compressed representation, e.g., by decompressing the compressed representation to yield (a reconstruction) of the combined embedding or providing the combined embedding as input and process the input using the reconstruction neural network 160 to reconstruct the data item.

As yet another example, the combined embedding can be used as a representation of the data item, e.g., a representation of an image or video in visual understanding tasks, e.g., image (or video)-text retrieval tasks, image (or video, or audio, or audiovisual) classification tasks (that is, inferring which of a set of classes an image (or video, or audio item) belongs to), image (or video) captioning tasks, segmentation (that is, identifying portions of an image, or video, or audio item having a certain property), generating control data for a real-world electromechanical agent (e.g., robot) based on an image or video of a real-world environment with which the agent interacts, and visual question answering tasks.

In some cases, the combined embedding can be used to perform multi-modal tasks by a multi-modal generative neural network 170.

For example, the downstream task can be a task performed by a generative model. As a particular example, the generative model can be a multi-modal generative neural network 170.

For example, the system 100 can process an input that includes the combined embedding and optionally, other tokens of other modalities using the multi-modal generative neural network 170 to generate an output for the downstream task.

As another example, the combined embedding can be used as part of a retrieval augmented generation (RAG) process performed by the multi-modal generative neural network 170. For example, the data item 102 can be provided as context for an input to the multi-modal generative neural network 170. The system 100 can use the combined embedding to retrieve similar data items from a repository of data items, e.g., by searching through embeddings of the data items in the repository to identify the nearest embeddings to the combined embedding. The system 100 can then process an input that includes the retrieved similar data items (or embedding of the retrieved similar data items), optionally in addition to the data item 102, the combined embedding, or both, using the multi-modal generative neural network 170.

The multi-modal generative neural network 170 can be, e.g., a multi-modal language model neural network or a different neural network that processes an input sequence of tokens to generate an output sequence of tokens. As a particular example of the above, the generative neural network can be an auto-regressive neural network that generates the tokens in the output sequence auto-regressively, i.e., one after another.

One example of such a neural network is a decoder-only Transformer neural network. Examples of such neural networks include Gemini (described in arXiv:2403.05530), Gemma (described in arXiv:2403.08295), and PaliGemma (described in arXiv:2412.03555).

Other examples of such neural networks are neural networks that include both recurrent and attention layers. Examples of such neural networks include Recurrent Gemma (described in arXiv:2404.07839) and Griffin (described in arXiv:2402.19427).

Other examples of such a neural network include recurrent neural networks. Examples of such neural networks include Hawk (described in arXiv:2402.19427).

In some cases, the generative neural network 170 can perform a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data, the data may be mapped into a common embedding space.

As a particular example, the task can be a multi-modal processing task that requires processing both text and image inputs. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

In particular, the neural network 170 is capable of receiving network inputs and generating network outputs for multiple different machine learning tasks. Generally, two machine learning tasks are different if they have different desired outputs for the inputs received for the tasks. For example, two image classification tasks can be different if the object categories into which each task requires classifying input images are different. As another example, two robot learning tasks can be different if the two tasks require generating outputs defining actions to be performed by a robot to reach two different goals.

In practice, for any of these examples, the task to be performed by the neural network 170 can be defined by (at least a part of) the network input, e.g., that is in the form of a prompt or a request received by the neural network. In other words, the neural network will be able to perform any of these tasks when an appropriate prompt or request is received.

Generally, the system 100 or another training system learns the respective learned transformations 130A-M for the one or more embedding neural networks 110A-M after the embedding neural networks 110A-N have already been trained.

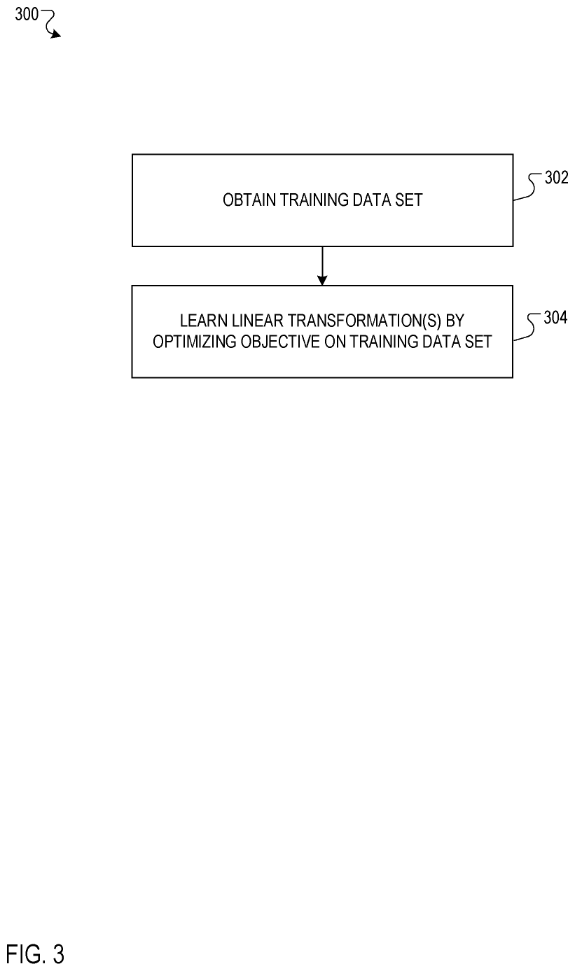

Learning the learned transformations will be described in more detail below with reference to FIG. 3.

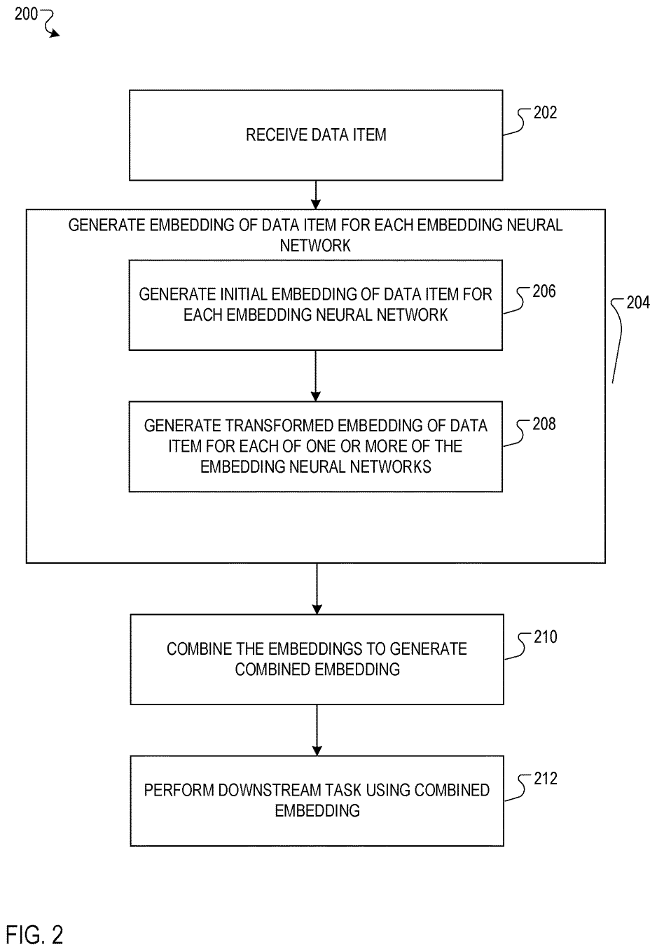

FIG. 2 is a flow diagram of an example process 200 for ensembling embeddings. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system receives a data item (step 202).

The system generates a respective embedding of the data item for each of a plurality of embedding neural networks (step 204). Generally, the respective embeddings for each of the embedding neural networks are embeddings in a shared space, i.e., each embedding has the same dimensionality.

As part of this, the system performs steps 206-208.

The system processes the data item using each of the plurality of embedding neural networks to generate a respective initial embedding of the data item for each embedding neural network (step 206). In some implementations, each initial embedding has the same dimensionality while, in other implementations, different embedding neural networks generate initial embeddings with different dimensionalities.

For each embedding neural network in a set of one or more of the embedding neural networks, the system applies a respective learned transformation for the embedding neural network to the respective initial embedding of the data item for the embedding neural network to generate a respective transformed embedding (step 208).

The system then uses the transformed embeddings as the embeddings of these data items. For any embedding neural network not in the set, the system uses the initial embedding of the data item as the embedding.

The respective learned transformation can be any appropriate transformation that has parameters that have been learned, i.e., that have had their values adjusted, during an optimization process.

For example, each respective learned transformation can be a respective linear transformation.

As another example, each respective learned transformation can be a non-linear transformation. As a particular example of this, each respective learned transformation can be a respective multi-layer perceptron (MLP).

The system combines the respective embeddings for the plurality of embedding neural networks to generate a combined embedding of the data item (step 210). The combined embedding generally has the same dimensionality as the embeddings, i.e., is in the same embedding space as the embeddings.

For example, the system can compute an average of the embeddings.

As another example, the system can compute a weighted sum of the embeddings.

As one example, in the case where there are two embedding neural networks f and g, the combined embedding h can be expressed as follows:

$$h = {α t}_{f} ( f ) + ( 1 - α ) {t}_{g} ( g ) ,$$

where α is a value between zero and one, t_{f} is the learned linear transformation for f and t_{g} is the learned linear transformation for g. The value for a is a hyperparameter and can be, e.g., received as input by the system or determined by the system through a hyperparameter search.

As another example, the system can fix t_{g} to be the identity mapping, so that only f has a learned linear transformation and, for g, the system uses the initial embedding as the embedding. That is, in the case where there are two embedding neural networks f and g, the combined embedding h can be expressed as follows:

$$h = {α t}_{f} ( f ) + ( 1 - α ) ( g ) .$$

The system performs a downstream task on a task input that includes the combined embedding of the data item (step 212).

For example, the downstream task can be a task performed by a generative model. As a particular example of this, the generative model can be a multi-modal generative model.

As one example, the downstream task can be a classification task that requires classifying the data item.

As another example, the downstream task can be a generative task that requires generating a new data item, e.g., a new data item has the same modality as the data item or a new data item has a different modality from the data item.

FIG. 3 is a flow diagram of an example process 300 for learning the learned transformations for the one or more embedding neural networks in the set. For convenience, the process 300 will be described as being performed by a system of one or more computers located in one or more locations. For example, a neural network system, e.g., the neural network system 100 of FIG. 1, appropriately programmed in accordance with this specification, can perform the process 300.

Generally, the system holds the plurality of embedding neural networks fixed while learning the one or more respective learned transformations. More specifically, the system does not require access to the parameters of any of the embedding neural network in order to learn the respective learned transformation(s).

The system obtains a training data set of training data items (step 302). In some cases, the training data set includes class labels for the training data items while, in other cases, the training data set does not.

The system learns the one or more respective learned transformations by optimizing an objective on the training data set (step 304). For example, the system can perform this optimization using an iterative optimization algorithm, e.g., stochastic gradient descent (SGD), that iteratively selects mini-batches of training data items and updates the respective learned transformation(s) using gradients of the objective computed for the mini-batch of training data items.

For example, the objective can include a first term that encourages, for each training data item, similarity between the respective embeddings generated for the training data item.

The system can use a variety of similarity losses as the first term.

For example, the first term can be an L2 loss. The L2 loss (also known as the least squares error or Euclidean loss) measures the sum of the squared differences between the embeddings. In the context of ensembling embeddings, an L2 loss term encourages the respective embeddings from different neural networks to be close to each other in the embedding space.

As another example, the first term can be a contrastive loss term. A contrastive loss term encourages representations (e.g., embeddings) of similar data items (positive pairs) to be close in the embedding space while simultaneously pushing representations of dissimilar data items (negative pairs) farther apart, typically beyond a certain margin.

As another example, the first term can be a triplet loss term. This loss considers an anchor embedding, a positive embedding (similar to the anchor), and a negative embedding (dissimilar to the anchor). It aims to ensure that the distance between the anchor and the positive is smaller than the distance between the anchor and the negative by at least a margin.

In some implementations, the objective also includes a second, regularization term. For example, this term can prevent the embeddings from becoming over-aligned and losing the variance-reducing benefit of ensembling. The regularization term can be any appropriate regularization term applied to, e.g., distances between embeddings of the same training data item.

For example, the system can use the objective that has the first term and optionally the second term when the training data set does not include class labels.

In some implementations, however, the training data set also includes a respective class label for each training data item.

In some of these implementations, the objective can include a classification loss term.

For example, the classification loss term can measure, for each training data item and for each of the plurality of embedding neural networks, a respective classification loss between (i) a classification output generated by applying a shared classification weight matrix to the respective embedding of the training data item for the embedding neural network and (ii) the respective target class label for the training data item. The classification matrix is referred to as being “shared” because the same classification weight matrix is applied to the embeddings of all of the embedding neural networks.

In this example, the shared classification matrix can be learned jointly with the one or more transformations.

For example, the classification loss can have a first term that measures, for the i-th training data item xᵢ with a class label yᵢ, an error between softmax(t_{f}(f(xᵢ); θ_{f})W) and yᵢ and a second term that measures an error between softmax(t_{g}(g(xᵢ); θ_{g})W) and yᵢ, where θ_{f} are the parameters of the linear transformation t_{f}, θ_{g} are the parameters of the linear transformation t_{g}, and W is the shared classification matrix.

As another example, the classification loss term can measure, for each training data item and for a first embedding neural network of the plurality of embedding neural networks, a respective classification loss between (i) a classification output generated by applying a second classification weight matrix to the respective transformed embedding of the training data item for the first embedding neural network and (ii) the respective target class label for the training data item. That is, the classification loss can measure an error between softmax(t_{f}(f(xᵢ); θ_{f})W_{g}) and yᵢ, where W_{g} is the second classification matrix.

In this example, the second classification weight matrix has been learned by optimizing a classification loss on initial embeddings generated by the second embedding neural network of the plurality of embedding neural networks. The system can use this classification loss when the second embedding neural network has no learned transformation.

That is, the system learns the second classification weight matrix using initial embeddings generated by a second, different embedding neural network and then applies the second classification weight matrix to respective transformed embeddings of training data items for the first embedding neural network to evaluate the classification loss term. For example, the system can have learned the second classification weight matrix jointly with the training of the second embedding neural network or can have learned the second classification weight matrix after training the second embedding neural network.

Thus, the second classification weight matrix is held fixed while learning the one or more transformations, i.e., after being learned using initial embeddings generated by the second embedding neural network.

In some other implementations where the training data set also includes a respective class label for each training data item, the objective can include a logit loss term.

For example, the logit loss term can measure, for each training data item and for a first embedding neural network of the plurality of embedding neural networks, a respective loss between (i) a first logit output generated by applying the second classification weight matrix to a respective transformed embedding of the training data item for the first embedding neural network and (ii) a second logit output generated by applying a first classification weight matrix to the respective initial embedding of the training data item for the first embedding neural network. That is, the logit loss can measure an error between t_{f}(f(xᵢ); θ_{f})W_{g} and f(xᵢ)W_{f}, where W_{f} is the first classification weight matrix.

In this example, the second classification weight matrix has been learned as described above and the first classification weight matrix has been learned by optimizing a classification loss on initial embeddings generated by the first embedding neural network. In this example, the first and second classification matrices are held fixed while learning the one or more transformations.

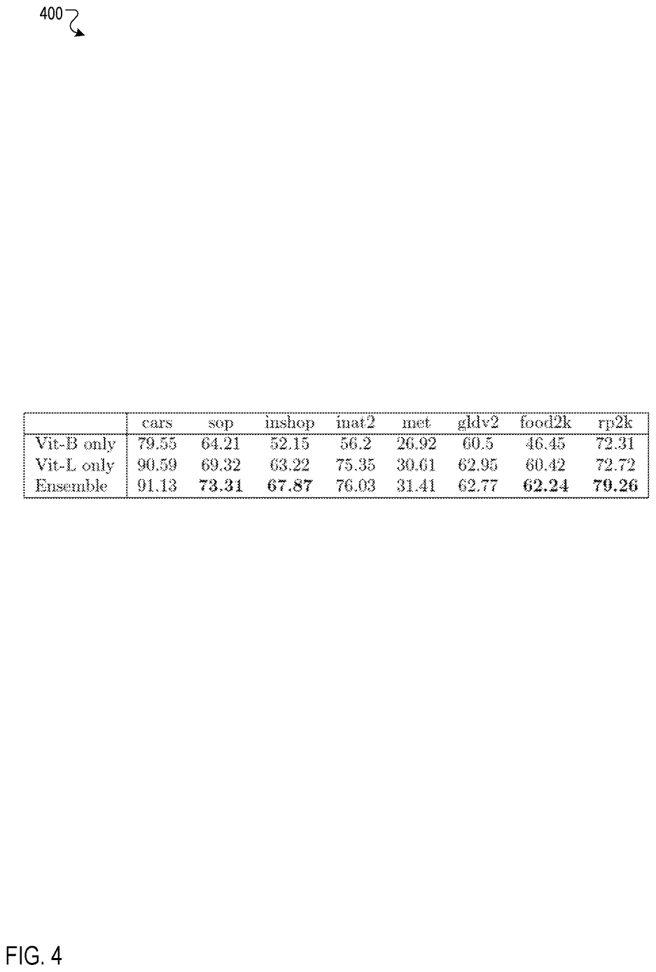

FIG. 4 is an example 400 of the performance of the described techniques. In particular, the example 400 shows the performance on eight different downstream tasks using embeddings from a Vision Transformer-Base (ViT-B) model, a Vision Transformer-Large (ViT-L) model, and combined embeddings generated by combining the ViT-B model embeddings and ViT-L model embeddings as described in this specification. For nearly all datasets, even though the performance of the ViT-B model is significantly worse than that of ViT-L, including it in the ensemble leads to a significant performance gain.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally, or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively, or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a data item;
generating a respective embedding of the data item for each of a plurality of embedding neural networks, comprising:
processing the data item using each of the plurality of embedding neural networks to generate a respective initial embedding of the data item for each embedding neural network; and
for each of one or more of the embedding neural networks, applying a respective learned transformation for the embedding neural network to the respective initial embedding of the data item for the embedding neural network to generate a respective transformed embedding and using the respective transformed embedding as the respective embedding of the data item for the embedding neural network;
combining the respective embeddings for the plurality of embedding neural networks to generate a combined embedding of the data item; and
performing a downstream task using the combined embedding of the data item.

2. The method of claim 1, wherein the downstream task is a task performed by a generative model.

3. The method of claim 2, wherein the generative model is a multi-modal generative model.

4. The method of claim 2, wherein performing the downstream task using the combined embedding of the data item comprises performing retrieval augmented generation using the combined embedding of the data item.

5. The method of claim 1, wherein the downstream task is a classification task that requires classifying the data item.

6. The method of claim 1, wherein the downstream task is a generative task that requires generating a new data item.

7. The method of claim 1, wherein the respective embeddings for each of the embedding neural networks are embeddings in a shared space.

8. The method of claim 1, wherein combining the respective embeddings for the plurality of embedding neural networks to generate a combined embedding of the data item comprises:
averaging the respective embeddings.

9. The method of claim 1, wherein combining the respective embeddings for the plurality of embedding neural networks to generate a combined embedding of the data item comprises:
computing a weighted sum of the respective embeddings.

10. The method of claim 1, wherein the one or more respective learned transformations have been learned by optimizing an objective on a training data set that comprises a plurality of training data items.

11. The method of claim 10, wherein the plurality of embedding neural networks have been held fixed while learning the one or more respective learned transformations by optimizing the objective on the training data set.

12. The method of claim 11, wherein the objective comprises a first term that encourages, for each training data item, similarity between the respective embeddings generated for the training data item.

13. The method of claim 10, wherein the training data set comprises a respective class label for each training data item, and wherein the objective comprises a classification loss term.

14. The method of claim 13, wherein the classification loss term measures, for each training data item and for each of the plurality of embedding neural networks, a respective classification loss between (i) a classification output generated by applying a shared classification weight matrix to the respective embedding of the training data item for the embedding neural network and (ii) the respective target class label for the training data item.

15. The method of claim 14, wherein the shared classification matrix is learned jointly with the one or more transformations.

16. The method of claim 13, wherein the classification loss term measures, for each training data item and for a first embedding neural network of the plurality of embedding neural networks, a respective classification loss between (i) a classification output generated by applying a second classification weight matrix to the respective transformed embedding of the training data item for the first embedding neural network and (ii) the respective target class label for the training data item, and wherein the second classification weight matrix has been learned by optimizing a classification loss on initial embeddings generated by a second embedding neural network of the plurality of embedding neural networks.

17. The method of claim 16, wherein the second classification weight matrix is held fixed while learning the one or more transformations.

18. The method of claim 10, wherein the training data set comprises a respective class label for each training data item, and wherein the objective comprises a logit loss term that measures, for each training data item and for a first embedding neural network of the plurality of embedding neural networks, a respective loss between (i) a first logit output generated by applying a second classification weight matrix to a respective transformed embedding of the training data item for the first embedding neural network and (ii) a second logit output generated by applying a first classification weight matrix to a respective initial embedding of the training data item for the first embedding neural network, wherein the first classification weight matrix has been learned by optimizing a classification loss on initial embeddings generated by the first embedding neural network, and wherein the second classification weight matrix has been learned by optimizing the classification loss on initial embeddings generated by a second embedding neural network of the plurality of embedding neural networks.

19. The method of claim 18, wherein the first and second classification matrices are held fixed while learning the one or more transformations.

20. A system comprising:
one or more computers; and
one or more storage devices communicatively coupled to the one or more computers, wherein the one or more storage devices store instructions that, when executed by the one or more computers, cause the one or more computers to perform operations comprising:
receiving a data item;
generating a respective embedding of the data item for each of a plurality of embedding neural networks, comprising:
processing the data item using each of the plurality of embedding neural networks to generate a respective initial embedding of the data item for each embedding neural network; and
for each of one or more of the embedding neural networks, applying a respective learned transformation for the embedding neural network to the respective initial embedding of the data item for the embedding neural network to generate a respective transformed embedding and using the respective transformed embedding as the respective embedding of the data item for the embedding neural network;
combining the respective embeddings for the plurality of embedding neural networks to generate a combined embedding of the data item; and
performing a downstream task using the combined embedding of the data item.

21. One or more non-transitory computer storage media storing instructions that when executed by one or more computers cause the one or more computers to perform operations comprising:
receiving a data item;
generating a respective embedding of the data item for each of a plurality of embedding neural networks, comprising:
processing the data item using each of the plurality of embedding neural networks to generate a respective initial embedding of the data item for each embedding neural network; and
for each of one or more of the embedding neural networks, applying a respective learned transformation for the embedding neural network to the respective initial embedding of the data item for the embedding neural network to generate a respective transformed embedding and using the respective transformed embedding as the respective embedding of the data item for the embedding neural network;
combining the respective embeddings for the plurality of embedding neural networks to generate a combined embedding of the data item; and
performing a downstream task using the combined embedding of the data item.
